(19) United States
(12) Patent Application Publication
(10) Pub. No.: US 2025/0072335 A1
(43) Pub. Date: Mar. 6, 2025

(54) STAKE TAG

(71) Applicant: Multi Packaging Solutions, Inc., Atlanta, GA (US)

(72) Inventor: Aaron MCDONALD, Edina, MN (US)

(21) Appl. No.: 18/825,639

(22) Filed: Sep. 5, 2024

Related U.S. Application Data
(60) Provisional application No. 63/580,609, filed on Sep. 5, 2023.

(51) Int. Cl. A01G 9/00; G09F 3/02

(52) U.S. Cl. CPC A01G 9/006; G09F 3/02883; G09F 2003/0269

(57) ABSTRACT

A tag that includes a stake portion, a connecting portion, and a display portion. The connecting portion is coupled to the stake portion by a first fold line. Additionally, the display portion is coupled to the connecting portion by a second fold line. Moreover, the tag is configured to be folded along the first fold line and the second fold line so that the display portion is positioned substantially parallel to the stake portion.

### TECHNICAL FIELD

This disclosure relates to tags, and more particular, to foldable stake tags that provide a display surface.

### BACKGROUND

Tags may often include graphics, such as images or textual information, that pertain to an associated item. The tags may include a means to connect the tag to the associated item. The tags may include a stake or other engaging portion that is configured to be inserted into a portion of the associated item to secure the tag in place. For example, a tag may include a stake that is configured to be inserted into the soil of a potted plant so that the tag may be positioned upright in the soil to display information about the plant (e.g., care instructions, price, barcode, etc.).

However, often when the tags are secured to their associated item (e.g., the tag is inserted into the soil of a potted plant), at least a portion of the tag may be obstructed by the object. For example, the tag may be partially inserted into the soil of the plant and a lip of the pot of the potted plant may partially obstruct information displayed on the tag. As a result, a customer may be unable to see the information on the tag and may be dissuaded from purchasing the potted plant.

### SUMMARY

In one aspect of the present disclosure, a tag is disclosed. The tag includes a stake portion, a connecting portion, and a display portion. The connecting portion is coupled to the stake portion by a first fold line. Additionally, the display portion is coupled to the connecting portion by a second fold line. Moreover, the tag is configured to be folded along the first fold line and the second fold line so that the display portion is positioned substantially parallel to the stake portion.

In some implementations, the stake portion may include tapered edges that converge at an insertion end of the stake portion. The insertion end may be configured to be inserted into soil to maintain a position of the tag for display. Additionally, the stake portion may further include a crease line extending inward from a terminal edge of the insertion end. Moreover, the crease line may extend transverse to the first fold line and the second fold line.

In some implementations, a length of the display portion may be greater than a length of the stake portion. Additionally, a length of the connecting portion may be less than the length of the display portion and less than the length of the stake portion.

In some implementations, the tag may further comprise a removable portion coupled to the display by a perforation. The perforation may be substantially parallel to the first fold line and the second fold line. Additionally, the display portion may include a display surface that is configured to display a first set of graphics and the removable portion may be configured to display a second set of graphics that is different from the first set of graphics.

In some implementations, the tag may be configured to be inserted into soil within a pot. The connecting portion may be configured to abut an upper edge of a lip of the pot. Additionally, the display portion may be configured to be positioned external of the pot and adjacent to an exterior surface of the pot. Moreover, an interior surface of the display portion may be configured to abut the exterior surface of the pot once the tag is inserted into the soil.

In some implementations, the first fold line and the second fold line may each include scoring and a perforation.

In another aspect of the present disclosure, a plant tag is disclosed. The plant tag includes a stake portion, a display portion, a connecting portion, and a removable portion. The stake portion is configured to be inserted into soil of a plant within a pot. The display portion is spaced apart from the stake portion and configured to display information pertaining to the plant. Additionally, the connecting portion is connected to the stake portion and the display portion, whereby the stake portion and the display portion are configured to be folded relative to the connecting portion. Moreover, the removable portion is connected to the display portion and configured to be separated from the display portion.

In some implementations, the display portion may be configured to be positioned adjacent to an exterior surface of the pot when the stake portion is inserted into the soil of the plant. The connecting portion may be configured to abut an upper edge of a lip of the pot when the stake portion is inserted into the soil. Moreover, the connecting portion may be positioned between the stake portion and the display portion. Additionally, the connecting portion may be connected to the stake portion by a first fold line that includes a perforation and scoring, and the connecting portion may be connected to the display portion by a second fold line that includes a perforation and scoring.

In some implementations, the stake portion, the display portion, and the connecting portion may be integrally formed with one another.

In another aspect of the present disclosure, a tag is disclosed. The tag includes a stake portion, a connecting portion, and a display portion. The stake portion has a first length as measured along a longitudinal axis of the tag. The connecting portion is connected to the stake portion by a first fold line and has a second length as measured along the longitudinal axis of the tag. Additionally, the display portion is connected to the stake portion by a second fold line and spaced apart from the stake portion, whereby the display portion has a third length as measured along the longitudinal axis of the tag. The third length is greater than the first length and the first length is greater than the second length.

In some implementations, tag may further include a removable portion connected to the display portion by a perforation and may be configured to be separated from the stake portion.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a front view of a first example of a tag in accordance with the present teachings.

FIG. 2 is a front view of a second example of a tag in accordance with the present teachings.

FIG. 3A is a perspective view of a tag inserted into a pot and folded for display.

FIG. 3B is a cross-sectional view of the tag of FIG. 3A in accordance with the present teachings.

FIG. 3C is a cross-sectional view of the tag of FIG. 3A in accordance with the present teachings.

### DETAILED DESCRIPTION

The present teachings generally relate to a tag. The tag may be configured to display information regarding an associated item. The tag may display text or images about the associated item, such as use and/or care instructions, a price, a barcode (e.g., the barcode may be scanned by a retail store to purchase the associated item), other information, or a combination thereof. The tag may be configured to display the aforementioned information in a manner that remains unobstructed by the associated item. For example, when the tag is secured to the associated item, the tag may still display the aforementioned information in a position that is easily viewable by a user.

As stated above, the tag may be used with an associated item. The associated item may be a consumer product, such as a plant, electronic device, furniture, tool, clothing, other consumer products, or a combination thereof. The associated item may be a commercial product, such as manufacturing equipment, chemical products, raw materials, construction equipment, other commercial products, or a combination thereof. The tag may be used with any item and is not limited to the items discussed above.

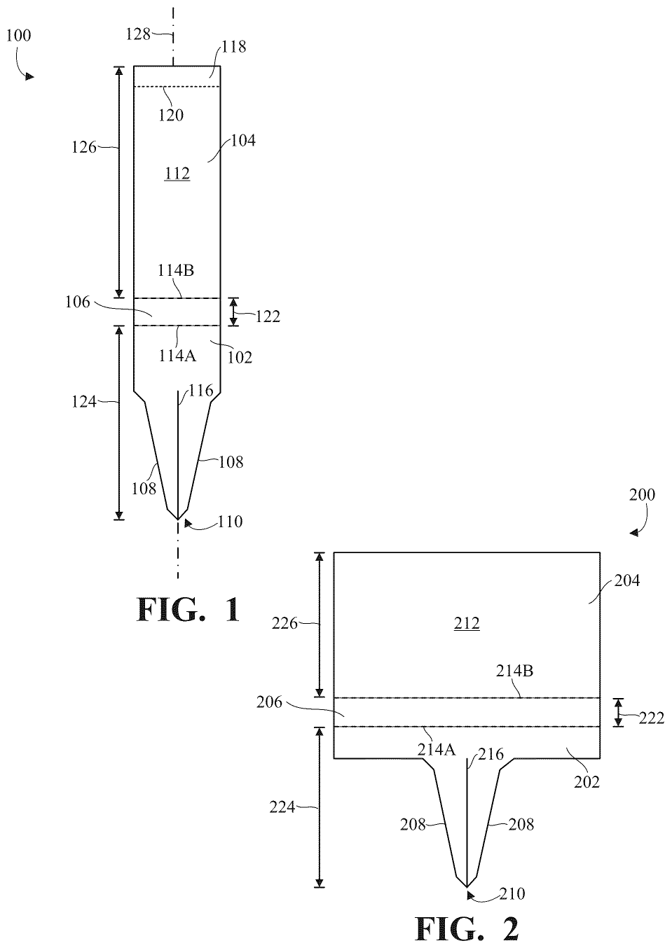

Turning now to the figures, FIG. 1 illustrates a front view of a tag 100. As discussed above, the tag 100 may be configured to display information pertaining to an item, such as graphics, text, or both. The tag 100 may also be configured to be secured to the item to ensure that the tag 100 remains connected to the item. The tag 100 may include one or more portions, such as a stake portion 102, a display portion 104, and a connecting portion 106.

To secure the tag 100 to the item, the tag 100 may include a stake portion 102. The stake portion may be configured to connect to the item and maintain a position of the tag 100 with respect to the item. As discussed in further detail below, the stake portion 102 may be configured to secure the tag 100 to a potted plant, such as by inserting at least a portion of the stake portion 102 into the soil of the potted plant. However, the stake portion 102 may be secured to other portions of any item. For example, the item may include a slot or receiving portion, and the stake portion 102 may be at least partially inserted into the slot or the receiving portion to secure the tag 100 to the item. Similarly, the item may include an interlocking feature, such as a clasp or fastener to secure the stake portion 102 to the item. For example, the stake portion 102 may be stapled or glued to packaging of the item or a designated location along the item. Therefore, the stake portion 102 may function as a designated region of the tag 100 that may be secured to the item.

The stake portion 102 may include one or more tapered edges 108. The tapered edges 108 may be configured to facilitate insertion into a portion of the item (e.g., the soil of a potted plant). The tapered edges 108 may extend along all or a portion of a terminal edge of the tag 100. The tapered edges 108 may be tapered related to an overall width of the tag 100, a width of the stake portion 102, or both. For example, the stake portion 102 may include tapered edges 108 that converge at an insertion end 110 of the stake portion 102. The tapered edges 108 may converge at the insertion end 110 to form an endpoint of the stake portion 102. That is, the insertion end 110 of the stake portion 102 may be the initial contact point between the stake portion 102 and the item during insertion of the stake portion 102 into the item. It should be noted that the stake portion 102 and the tapered edges 108 may be any desired shape. For example, the tapered edges 108 may diverge towards the insertion end 110 as opposed to converging in certain circumstances. As such, any contour, angles, or shape may be formed with the tapered edges 108. For example, the tapered edges 108 may include a jagged portion, such as teeth, that further aid with insertion of the stake portion 102 into the item.

As stated above, the insertion end 110 may be configured to be inserted into the item (e.g., soil of a potted plant) to maintain a position of the tag 100 for display. Display of the tag 100 may allow for unobstructed sight of graphics and/or text on the tag 100, such as graphics and/or text disposed on a display surface 112 of the display portion 104 of the tag 100. To maintain the position of the tag 100, the insertion end 110 may form a point, rounded edge, or other terminal end of the stake portion 102 that may initially contact the item (e.g., soil of a potted plant) and be inserted into the item. As a result, the insertion end 110 may be recessed from a surface of the item along with at least a portion of the tapered edges 108, at least a portion of the stake portion 102 other than the tapered edges 108, or both.

The display portion 104 may be spaced apart from the stake portion 102 and may be configured to display information pertaining to the item. That is, graphics and/or text may be disposed on the display surface 112 of the display portion 104. The display surface 112 may be all or a portion of the display portion 104. Additionally, the graphics and/or text displayed on the display surface 112 are not limited based on the present teachings. The graphics and/or text may be any information visible by a user (e.g., a customer) and may be printed directly onto the display surface 112 or otherwise coupled to the display surface. For example, the graphics and/or text may be printed onto a label, and the label may be adhered to the display surface 112.

The connecting portion 106 may be connected to the stake portion 102 and the display portion 104. The connecting portion 106 may be positioned between the stake portion 102 and the display portion 104 so that the stake portion 102 and the display portion 104 may be free of contact with one another. For example, the connecting portion 106 may be coupled to the stake portion 102 by a first fold line 114A and the display portion 104 may be coupled to the connecting portion 106 by a second fold line 114B, whereby the tag 100 may be configured to be folded along the first fold line 114A and the second fold line 114B so that that display portion 104 may be positioned substantially parallel to the stake portion 102 after folding. As discussed in detail below, the stake portion 102 and the connecting portion 106 may be folded relative to one another along the first fold line 114A. Similarly, the display portion 104 and the connecting portion 106 may be folded relative to one another along the second fold line 114B. As a result, the tag 100 may be folded so that the display portion 104—and in particular the display surface 112—may display the information thereon free of obstruction, even after the tag 100 is secured to the item.

The first fold line 114A and the second fold line 114B may extend across a width of the tag 100. The first fold line 114A and the second fold line 114B may extend transverse or nonparallel with respect to a length of the tag 100. As discussed further below, the first fold line 114A and the second fold line 114B may extend transverse to the crease line 116 of the stake portion 102. However, the first fold line 114A and the second fold line 114B may extend in any desired direction along the tag 100. Additionally, the first fold line 114A and the second fold line 114B may be spaced apart from one another in any desired manner. The first fold line 114A and the second fold line 114B may converge towards one another, diverge from one another, or both. The first fold line 114A and the second fold line 114B may be free of contact with one another and may neither converge nor diverge. For example, the first fold line 114A and the second fold line 114B may be substantially parallel to one another.

The first fold line 114A and the second fold line 114B may be substantially uniform and may be formed in a similar manner. For example, the connecting portion 106 may be connected to the stake portion 102 by a first fold line 114A that includes a perforation and scoring. Additionally, the portion 106 may be connected to the display portion 104 by a second fold line 114B that includes a perforation and scoring. The perforation and the scoring of the first fold line 114A may be the same as the perforation and the scoring of the second fold line 114B. The perforation and the scoring may extend along all or a portion of the first fold line 114A and the second fold line 114B. The perforation may be considered a plurality of perforated slits that extend through a thickness of the tag 100 and may be spaced apart along the first fold line 114A and the second fold line 114B by portions of the tag 100 that remain uncut. Additionally, the scoring may by a cut through only a portion of the thickness of the tag 100 to further facilitate folding of the tag 100.

The stake portion 102 may further include a crease line 116 extending inward from a terminal edge of the insertion end 110, such as a terminal endpoint formed by the tapered edges 108 converging at the insertion end 110. The crease line 116 may be a partial fold or scoring that allows for the stake portion 102 to be at least partially folded relative to itself. The crease line 116 may increase the structural integrity of the stake portion 102 to prevent bending or deflection of the stake portion 102 during insertion of the stake portion 102 into the item. The crease line 116 may extend inward from the insertion end 110 into a central region of the stake portion 102 so that the crease line 116 is space apart from the tapered edges 108 and only contacts an edge of the tag 100 at a point located at the insertion end 110. For example, the crease line 116 may extend transverse to the first fold line 114A and the second fold line 114B so that the crease line 116 is substantially perpendicular to both the first fold line 114A and the second fold line 114B.

The tag 100 may also include a removable portion 118 coupled to the display portion 104 by a perforation 120. As discussed above, the display portion 104 may include the display surface 112 that is configured to display graphics or information regarding an associated item. Similarly, the removable portion 118 may be configured to display additional graphics or information regarding the associated, whereby the removable portion 118 may be an extension of the display portion 104. The display portion 104 may include the display surface 112 that is configured to display a first set of graphics (e.g., text, images, etc.) and the removable portion 118 may be configured to display a second set of graphics (e.g., text, images, etc.) that is different from the first set of graphics display on the display surface 112. For example, the display surface 112 may contain use and/or care information regarding a plant and the removable portion 118 may display a price and/or a barcode for purchasing the plant. The display surface 112 and the removable portion 118 may also contain the same information in certain configurations.

The removable portion 118 may be connected to the display portion 104 and configured to be separated from the display portion 104. As stated above, the removable portion 118 may be connected or separated from the display portion 104 by the perforation 120. The removable portion 118 may be removed from the display portion 104 along the perforation 120, such as by tearing the removable portion 118 off the display portion 104 along the perforation 120. It should be noted that the removable portion 118 may be considered part of the display portion 104 and/or part of the display surface 112 such that the removable portion 118 may be a removable extension of the display portion 104 and/or the display surface 112.

As shown in FIG. 1, the perforation 120 may extend across a thickness of the display portion 104 between opposing terminal edges (e.g., side edges) of the tag 100. The perforation 120 may be substantially parallel to the first fold line 114A and the second fold line 114B. The perforation 120 may be positioned transverse to the longitudinal axis 128 of the tag 100. For example, the perforation 120 may extend substantially perpendicular to the longitudinal axis 128 of the tag 100. The perforation 120 may extend in any desired direction or at any desired angle relative to the longitudinal axis 128. The perforation 120 may extend across only a portion of the width of the tag 100 or an entirety of the width of the tag 100. The perforation 120 may be one or more punctures or cuts that extend through a thickness of the tag 100. The perforation 120 may be punctures or cuts that extend through a portion of the thickness of the tag 100. As such, the perforation 120 may not be limited to any one pattern.

Additionally, as shown in FIG. 1, the removable portion 118 may be positioned adjacent to the display portion 104 along a top edge of the display portion 104 (e.g., the edge of the display portion 104 that is transverse to the longitudinal axis 128 of the tag 100). The removable portion 118 may also be positioned adjacent to another edge of the display portion 104, such as one of the opposing side edges that extend substantially parallel to the longitudinal axis 128 of the tag 100. Therefore, the removable portion 118 may be located anywhere with respect to the display portion 104. Additionally, the removable portion 118 may also be connected to the connecting portion 106, the stake portion 102, or both.

The size and/or shape of the stake portion 102, the display portion 104, and the connecting portion 106 may vary and are not limited to any particular dimensions. The stake portion 102 may have a length 124 (e.g., a first length), the connecting portion 106 may have a length 122 (e.g., a second length), and the display portion 104 may have a length 126 (e.g., a third length). The length 124 of the stake portion 102, the length 122 of the connecting portion 106, and the length 126 of the display portion 104 may all be measured along a longitudinal axis 128 of the tag 100. The length of the stake portion 102, the length 122 of the connecting portion 106, and the length 126 of the display portion 104 may vary and not particularly limited. For example, the length 126 (e.g., the third length) of the display portion 104 may be greater than the length 124 (e.g., the first length) of the stake portion 102 and the length 124 (e.g., the first length) of the stake portion 102 may be greater than the length 122 (e.g., the second length) of the connecting portion 106. That is, the length 126 of the display portion 104 may be greater than the length 124 of the stake portion 102. Additionally, the length 122 of the connecting portion 106 may be less than the length 126 of the display portion 104 and the length 124 of the stake portion 102. However, the above dimensions may vary depending on the item that the tag 100 may be connected to for display purposes. For example, the tag 100 may be inserted into the soil of a potted plant and the soil may be recessed from a top edge of the pot, thereby requiring that the length 124 of the stake portion 102 be increased to be greater than the length 126 of the display portion 104. Similarly, the length 122 of the connecting portion 106 may be increased or decreased based upon a thickness of the pot containing the plant (e.g., a thickness of a lip of the pot). Thus, the tag 100 may vary in dimensions to accommodate various items.

The tag 100 may be made from any desired material. The tag 100 may be made from one or more polymers. The tag 100 may be made from polypropylene, polyvinyl, other plastics, or a combination thereof. The tag 100 may be made from one or more bioplastics. The tag 100 may be made from paper, cardstock, cardboard, or a combination thereof. The tag 100 may be biodegradable. The tag 100 may be ultraviolet (UV) resistant, antimicrobial, antifungal, moisture resistant, or a combination thereof. Thus, the tag 100 may not be limited to any particular material, and such material may be selected based upon a desired application. For example, the tag 100 may be made from a moisture resistant material and/or a biodegradable material if the tag 100 will be inserted into the soil of a potted plant to ensure the tag 100 does not deteriorate. Additionally, the tag 100 may be a laminate or may a single layer. For example, the tag 100 may be a monolithically formed material. That is, the stake portion 102, the display portion 104, and the connecting portion 106 may be integrally formed with one another from a single piece, thereby improving the overall manufacturing process.

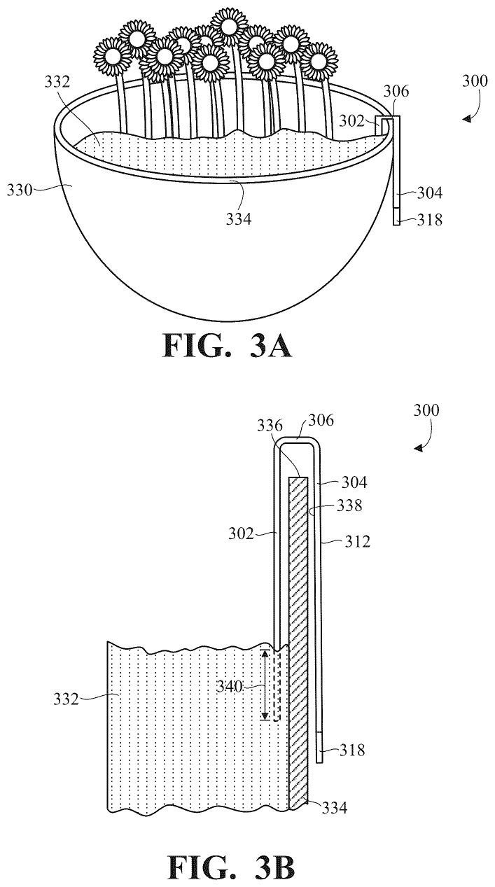

FIG. 2 illustrates a front view of another tag 200. The tag 200 may be similar to the tag 100 discussed above unless otherwise stated. The tag 200 may include a stake portion 202, a display portion 204, and a connecting portion 206. The stake portion 202 may be similar to the stake portion 102, the display portion 204 may be similar to the display portion 104, and the connecting portion 206 may be similar to the connecting portion 106.

The tag 200 may be configured to be secured to an item to provide information regarding the item. By way of example, the tag 200 may be secured to a plant, such as a potted plant. The stake portion 202 may be configured to be inserted into soil of the plant within the pot. For example, the stake portion 202 may include one or more tapered edges 208 that terminate at an insertion end 210 of the stake portion 202, whereby the insertion end 210 may be inserted into the soil. Additionally, the display portion 204 may be spaced apart from the stake portion 202 and configured to display information pertaining to the plant on a display surface 212 when the stake portion 202 is inserted into the soil, thereby ensuring the information is visible by a user (e.g., a customer).

The connecting portion 206 may be connected to the stake portion 202 and the display portion 204 and may separate the stake portion 202 from the display portion 204. The connecting portion 206 may be connected to the stake portion 202 by a first fold line 214A. The connecting portion 206 may also be connected to the display portion 204 by a second fold line 214B. The first fold line 214A and the second fold line 214B may be similar to the first fold line 114A and the second fold line 114B of the tag 100 described above. As a result, the stake portion 202 and the display portion 204 may be configured to be folded relative to the connecting portion 206 along the first fold line 214A and the second fold line 214B.

Folding of the tag 200 may facilitate positioning the display portion 204 external to the plant or other item, such as adjacent to an exterior surface of the pot of the plant. Similarly, the tag 200 may be folded so that the display portion 204 is positioned in a location that remains unobstructed by the plant or other item, thereby ensuring that a user (e.g., a customer) may easily read or view the information displayed on the display surface 212. Additionally, to maintain a position of the tag 200 when secured to the plant or other item, a crease line 216 may extend along a portion of the stake portion 202, such as inward from the insertion end 210, to improve the structural integrity of the tag 200 and prevent unwanted buckling or deflection of the stake portion 202 during insertion into the soil.

The tag 200 may have a similar structure to the tag 100 while dimensions of portions of the tag 200 may be different than dimensions of portions of the tag 100. The connecting portion 206 may have a length 222 that may be the same or different from the length 122 of the connecting portion 106 of the tag 100. Additionally, the stake portion 202 may have a length 224 that may be the same or different from the length 124 of the stake portion 102 of the tag 100. Furthermore, the display portion 204 may have a length 226 that may the same or different from the length 124 of the display portion 104 of the tag 100. As a result, the tag 200 may provide an alternative shape and/or configuration for various items, such as potted plants that may vary in size and/or shape.

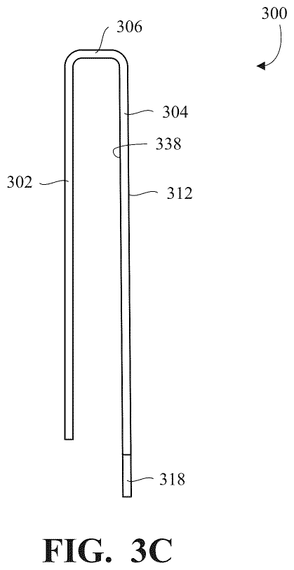

FIG. 3A illustrates a perspective view of a tag 300 inserted into a pot 330. FIG. 3B illustrates a cross-sectional view of the tag 300 inserted into the pot 330 with the pot 330 removed for simplicity. Additionally, FIG. 3C illustrates a cross-sectional view of the tag 300 in folded and configured to be inserted into the pot 330. The tag 300 may be similar to the tag 100 and the tag 200 described above. The tag 300 may include a stake portion 302 that is configured to be inserted into soil 332 of the plant located within the pot 330. The tag 300 may also include a display portion 304 spaced apart from the stake portion 302 that is configured to display information pertaining to the plant with the pot 330. Additionally, a connecting portion 306 may be connected to the stake portion 302 and the display portion 304.

As shown, the stake portion 302 and the display portion 304 may be configured to be folded relative to the connecting portion 306 so that the display portion 304 may be configured to be positioned adjacent to an exterior surface of the pot 330 when the stake portion 302 is inserted into the soil 332 of the plant. Additionally, the connecting portion 306 may be configured to abut an upper edge 336 of a lip 334 of the pot 330 when the stake portion 302 is inserted into the soil 332. For example, an insertion depth 340 of the stake portion 302 into the soil 332 may be determined by the connecting portion 306 contacting the lip 334 (e.g., the upper edge 336 of the lip 334) of the pot 330.

As stated above, once the tag 300 is inserted into the soil 332 (e.g., the stake portion 302 is inserted into the soil 332), the display portion 304 may be positioned external of the pot 330 and adjacent to the exterior surface of the pot 330. An interior surface 338 of the display portion 304 that opposes a display surface 312 of the display portion 304 may be configured to abut or be positioned adjacent to the exterior surface of the pot 330 once the tag 300 is inserted into the soil 332. Positioning of the display portion 304 relative to the pot 330 may vary based upon folding of the tag 300. As a result, the tag 300 may be secured in the soil 332 and may not require any secondary fastener or adhesive to secure the tag 300 to the pot 330. Additionally, the tag 300 may be secured in the soil 332 so that the pot 330 may not require any secondary feature to connect the tag 300, such as a slot or interlocking portion.

The tag 300 may also include a removable portion 318 connected to the display portion 304 and configured to be separated from the display portion 304. The removable portion 318 may include additional information on a surface of the removable portion 318 may be substantially planar with the display surface 312 of the display portion 304. As discussed above, the removable portion 318 may include similar or different information than the information provided on the display surface 312 of the display portion 304.

As shown in FIGS. 3A-3C, the display portion 304 may be folded relative to the stake portion 302, or vice versa, so that the display portion 304 and the stake portion 302 are positioned substantially parallel to one another. When folded, the display portion 304 and the stake portion 302 may be spaced apart from one another based upon a length of the connecting portion 306 extending between the display portion 304 and the stake portion 302. That is, a length of the connecting portion 306 as measured along the longitudinal axis of the tag 300 may determine the distance of a gap or width between the display portion 304 and the stake portion 302 when the tag 300 is folded (e.g., such as when the tag 300 is folded and inserted into the pot 330 shown in FIG. 3A). Additionally, when folded, the connecting portion 306 may be substantially perpendicular relative to the display portion 304 and/or the stake portion 302. It should be noted that the tag 300 may be folded in other manners to accommodate various pots or other items for display. For example, the tag 300 may be folded so that the display portion 304 is substantially perpendicular to the stake portion 302 or nonparallel to the stake portion 302.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A tag, comprising:
a stake portion;
a connecting portion coupled to the stake portion by a first fold line; and
a display portion coupled to the connecting portion by a second fold line,
wherein the tag is configured to be folded along the first fold line and the second fold line so that the display portion is positioned substantially parallel to the stake portion.

2. The tag of claim 1, wherein the stake portion includes tapered edges that converge at an insertion end of the stake portion, and wherein the insertion end is configured to be inserted into soil to maintain a position of the tag for display.

3. The tag of claim 2, wherein the stake portion further includes a crease line extending inward from a terminal edge of the insertion end.

4. The tag of claim 3, wherein the crease line extends transverse to the first fold line and the second fold line.

5. The tag of claim 1, wherein a length of the display portion is greater than a length of the stake portion.

6. The tag of claim 5, wherein a length of the connecting portion is less than the length of the display portion and less than the length of the stake portion.

7. The tag of claim 1, further comprising:
a removable portion coupled to the display portion by a perforation, wherein the perforation is substantially parallel to the first fold line and the second fold line.

8. The tag of claim 7, wherein the display portion includes a display surface that is configured to display a first set of graphics, and wherein the removable portion is configured to display a second set of graphics that is different from the first set of graphics.

9. The tag of claim 1, wherein the tag is configured to be inserted into soil within a pot, and wherein the connecting portion is configured to abut an upper edge of a lip of the pot.

10. The tag of claim 9, wherein once the tag is inserted into the soil, the display portion is configured to be positioned external of the pot and adjacent to an exterior surface of the pot.

11. The tag of claim 10, wherein an interior surface of the display portion is configured to abut the exterior surface of the pot once the tag is inserted into the soil.

12. The tag of claim 1, wherein the first fold line and the second fold line each include scoring and a perforation.

13. A plant tag, comprising:
a stake portion configured to be inserted into soil of a plant within a pot;
a display portion spaced apart from the stake portion and configured to display information pertaining to the plant;
a connecting portion connected to the stake portion and the display portion, wherein the stake portion and the display portion are configured to be folded relative to the connecting portion; and
a removable portion connected to the display portion and configured to be separated from the display portion.

14. The plant tag of claim 13, wherein the display portion is configured to be positioned adjacent to an exterior surface of the pot when the stake portion is inserted into the soil of the plant.

15. The plant tag of claim 14, wherein the connecting portion is configured to abut an upper edge of a lip of the pot when the stake portion is inserted into the soil.

16. The plant tag of claim 13, wherein the connecting portion is positioned between the stake portion and the display portion.

17. The plant tag of claim 16, wherein the connecting portion is connected to the stake portion by a first fold line that includes a perforation and scoring, and
wherein the connecting portion is connected to the display portion by a second fold line that includes a perforation and scoring.

18. The plant tag of claim 13, wherein the stake portion, the display portion, and the connecting portion are integrally formed with one another.

19. A tag, comprising:
a stake portion that has a first length as measured along a longitudinal axis of the tag;
a connecting portion connected to the stake portion by a first fold line, wherein the connecting portion has a second length as measured along the longitudinal axis of the tag; and
a display portion connected to the stake portion by a second fold line and spaced apart from the stake portion, wherein the display portion has a third length as measured along the longitudinal axis of the tag,
wherein the third length is greater than the first length and the first length is greater than the second length.

20. The tag of claim 19, further comprising:
a removable portion connected to the display portion by a perforation and configured to be separated from the stake portion.
